(19) United States
(12) Patent Application Publication
(10) Pub. No.: US 2003/0024556 A1
(43) Pub. Date: Feb. 6, 2003

(54) Foaming composition containing fibers and surfactant

(75) Inventors: Carole Guiramand, Jouy En Josas (FR); Valerie Hurel, Gif/S/Yvette (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: L'OREAL, Paris (FR)

(21) Appl. No.: 10/137,353

(22) Filed: May 3, 2002

(30) Foreign Application Priority Data
May 3, 2001 (FR) 0105927

(51) Int. Cl. B08B 1/00

(52) U.S. Cl. 134/42

(57) ABSTRACT

The present invention relates to a foaming composition suitable for topical application, containing fibers and a surfactant system such that at least one direct hexaganol or cubic paracrystalline phase appears when the temperature increases beyond 30° C., where this paracrystalline phase remains present up to at least 45° C. The surfactant system preferably contains at least one water-soluble surfactant and at least one surfactant which is insoluble in water. It preferably contains at least one water-soluble soap. The invention compositions may be present in the form of creams and they have a good physical stability at ambient temperature and even up to at least 45° C. They can be especially used in the cosmetic or dermatological fields, as products for cleansing or for removing make-up from the skin, the scalp and/or the hair, etc.

### BACKGROUND OF THE INVENTION

1. Field of the Invention

The present invention relates to a preferably rinsable foaming composition, preferably forming a cream for topical application. The invention foaming composition contains fibers and a special surfactant system and preferably has good physical stability up to at least 45° C. The invention compositions are useful in the cosmetic and dermatological fields, especially as products for cleansing or for removing make-up from the skin, the scalp and/or the hair.

2. Discussion of the Background

Cleansing of the skin is very important for the care of the face. It must be as effective as possible, because the fatty residues such as the excess of sebum, the residues of cosmetic products used daily and make-up products, especially the “waterproof” products resistant to water, accumulate in the cutaneous folds and can obstruct the pores of the skin and cause the appearance of pimples.

In order to improve the cleansing of the skin and also the cosmetic quality of cleansing products for the human skin, it is known to incorporate in these cleansing products charges which can improve the softness and the texture of the products and which can also complete the cleansing effect by their capability to remove dead cells from the skin, for example when the charges are erasing compounds or abrasives. Beside these charges, an attempt has been made to use fibers as an abrasive or to improve the erasing effect of the abrasives present in the cleansing product. Thus, the documents JP-A-61-77907 and JP-A-9-20647 describe cleansing products containing fibers to improve the detergent and erasing effect of these products, and the document EP-A-336900 describes a cleansing composition containing polyester fibers as an abrasive.

However, the incorporation of fibers in the cleansing compositions involves problems, owing to the fact that the fibers, from the smallest proportions, can contribute modifications of the cosmetic quality and of the viscosity of the compositions. Thus, the modifications of the cosmetic qualities can be manifested by a possible yellowing of the composition if its preparation process comprises a heating phase, by the development of odor or by a less smooth appearance of the composition, as examples. In addition, the fibers can cause harmful variations in the physicochemical stability of these compositions. However, it is indispensable that this type of product is stable over a wide range of temperatures. In fact, in the course of its period of use, the product can be exposed to temperatures ranging from −20° C. to +45° C. minimum according to the climatic, storage and/or transport conditions. For example, it is necessary that a product transported in a vehicle which risks remaining for a long time in the sun, that is to say at a temperature easily reaching 50° C., preserves its stability. It is also necessary that these cleansing products may be used in hot countries without their transport and their preservation posing a problem.

### OBJECT OF THE INVENTION

There thus remains the need for a cleansing composition containing fibers, which is stable even at temperatures greater than ambient temperature, for example up to at least 45° C., which even with significant proportions of fibers, remains stable and preserves a good foaming performance and good cosmetic qualities.

### SUMMARY OF THE INVENTION

Surprisingly, the applicant found that it is possible to introduce fibers into a foaming composition having a special surfactant system, even in a significant quantity (for example more than 5% of fibers) while retaining good cosmetic properties, a good quality of foaming, homogeneous spreading and a good physico chemical stability (over time and at different temperatures) and in so doing with fibers of different kinds. In addition, the composition according to the invention containing fibers is differentiated from a conventional foaming cream by its more mat appearance.

### DETAILED DESCRIPTION OF THE INVENTION

The surfactant system used in the present invention is such that at least one paracrystalline phase of the direct or cubic hexagonal type appears when the composition is heated to a temperature of greater than 30° C. and that this paracrystalline phase remains present up to at least 45 ° C.

The composition obtained occurs in the form of a foaming cream. “Foaming creams” are understood here as meaning opaque, viscous compositions, often marketed in a tube and generally formed of an aqueous medium containing a mixture of surfactants.

In order to obtain the required stability, it is preferred that the paracrystalline phase formed (or liquid crystal phase) is a direct hexagonal phase. It is not necessary that this paracrystalline phase be present at ambient temperature but it must appear in this preferred embodiment between 30° C. and 45° C.

Thus, one subject of the present application is a foaming composition for topical application, containing, in an aqueous medium, fibers and a surfactant system such that at least one paracrystalline phase of direct hexagonal, cubic, or mixture thereof, appears when the temperature increases beyond 30° C. and that this paracrystalline phase remains present up to at least 45 ° C.

“Topical application” is understood here as meaning an external application to the keratinous materials, and “keratinous materials” are especially understood as meaning the skin, the scalp, the eyelashes, the eyebrows, the nails and the mucous membranes.

The composition according to the invention, when intended for topical application preferably comprises a physiologically acceptable medium, that is to say a medium compatible with all the keratinous materials such as the skin including the scalp, the nails, the mucous membranes, the eyes and the hair or any other cutaneous area of the body. It can especially form a cosmetic or dermatological composition.

The compositions according to the invention containing fibers not only have good foaming properties but also good cosmetic properties: comfort in application, a texture which is easy to spread, and soft.

The paracrystalline phase(s) present beyond +30° C. can be of the direct hexagonal type or cubic type, or can be a mixture of these two phases or a mixture of one of these phases or of these two phases with a phase of lamellar type. The paracrystalline phase(s) preferably contain(s) at least one direct hexagonal phase.

In the present application, the terms lamellar phase, direct hexagonal phase and cubic phase are given the meanings which are customarily given to them by the person skilled in the art.

Thus, lamellar phase (phase D according to EKWALL, see Advances in Liquid Crystals, vol. 1, page 1-143, Acad. Press, 1975, Ed. G. H. Brown), is understood as meaning a liquid crystal phase with plane symmetry, comprising a number of amphiphilic bilayers arranged in parallel and separated by a liquid medium which is generally water.

Direct hexagonal phase (phase F according to EKWALL, see Advances in Liquid Crystals, vol. 1, page 1-143, Acad. Press, 1975, Ed. G. H. Brown), is understood as meaning a liquid crystal phase corresponding to a hexagonal arrangement of parallel cylinders formed of an amphiphile and separated by a liquid medium which is generally water. In a direct hexagonal phase, the continuous medium is aqueous.

Cubic phase is understood as meaning a phase organized in a bipolar manner in distinct hydrophilic and lipophilic domains, in close contact and forming a tridimensional system with thermodynamically stable cubic symmetry. Such an organization has especially been described in “La Recherche” [Research], Vol. 23, pp. 306-315, March 1992 and in “Lipid Technology”, Vol. 2, No. 2, pp. 42-45, April 1990. Depending on the arrangement of the hydrophilic and lipophilic domains, the cubic phase is said to be of normal or inverse type. The term cubic phase used according to the present invention includes these different types of cubic phases.

A more precise description of these phases can be found in the Revue Français des Corps Gras [French Review of Fats], No 2., February 1969, p@ 87 to 111, (Lachampt and Vila, “Textures des phases paracristallines” [Textures of paracrystalline phases]).

In order to identify the constitutive phases of the cream, it is possible to use different techniques, and especially (1) measurements by small angle and large angle X-ray diffraction and (2) observation by optical microscopy in polarized light, all within the skill of the ordinary artisan.

X-ray Diffraction Technique

The X-ray diffraction technique is known as being one of the most pertinent for demonstrating the organization of paracrystalline phases, in particular in a sample. The X-ray diffraction measurements can be carried out with the aid of a Sigma 2060 CGR generator equipped with an Inel tube with Cu anticathode and a linear focusing chamber mounted in symmetrical transmission. The samples are introduced at ambient temperature into a measurement cell sealed by windows of Mylar or of Capton and placed in a thermocontrolled sample holder.

The diffraction spectra obtained with a wavelength λ=1.54 Angströms (copper Kα line) are recorded with the aid of a screen photostimulable with phosphorus scanned by a Molecular Dynamics PhosphorImager PSI laser scanning module. The detector/sample distance is controlled at 133 mm, which gives access to lattice distances of between approximately 3 and 110 Angströms. The spectra are recorded at different fixed temperatures.

With this technique, the paracrystalline phases are characterized by the presence, at small diffraction angles, of a series of a number of fine lines due to Bragg reflections and corresponding to distances: d1, d2 . . . dn with distance ratios d1/d1, d1/d2, . . . , d1/dn which are characteristic of each type of phase, as indicated, for example, in “La structure des colloïdes d'association, I. Les phases liquides crystallines des systèmes amphiphile-eau” [The structure of associative colloids. I. Liquide crystal phases of amphiphile/water systems], V. Luzzati, H. Mustachi, A. Skoulios and F. Husson, Acta Cryst. (1960), 13, 660-667 or in Biochimica et Biophysica Acta (1990), 1031, p. 1 to 69, of J. M. Seddon. Thus, for a phase of lamellar structure and in particular for the paracrystalline phase of fluid lamellar type generally denoted by Lα and also called neat phase, the distance ratios are equal to: 1, 2, 3, 4, . . . . For the paracrystalline phase of direct hexagonal type generally denoted by H1 or E and also called middle phase, the distance ratios are equal to: 1, √3, 2, √7, . . . . At large diffraction angles, paracrystalline phases have a central band at a distance of the order of 4.5 Angströms, whereas crystalline phases lead to fine lines.

Observations by Optical Microscopy

Observations by optical microscopy in polarized light likewise contribute to the identification of the paracrystalline phases, in particular when the number of lines observed by X-ray diffraction is insufficient to establish without ambiguity the nature of the paracrystalline phases present.

Optical microscopy observations in polarized light are carried out, for example, with the aid of a LABORLUX S (LEITZ) microscope equipped with an objective of magnification 10, a crossed polarizer system and a heating plate (METTLER FP80/FP82). The sample is placed between microscope slide and cover glass, covered again by a second slide and sealing of the whole through the intermediary of a parafilm joint. The observations are carried out at various fixed temperatures or by temperature scanning at 2° C./min between ambient temperature and approximately 95° C.

It is known, for example, that isotropic micellar solutions are nonbirefringent, that paracrystalline phases of cubic type are likewise nonbirefringent and that direct or inverse hexagonal paracrystalline phases of fluid lamellar type show, in polarized light, various characteristic textures described, for example, in “Textures des phases paracrystallines rencontrées dans les diagrammes d'équilibres: agents de surface, lipides, eau” [Textures of paracrystalline phases found in equilibrium diagrams: surface agents, lipids and water], F. Lachampt and R. M. Vila, Revue Française des corps gras (1969), 2, 87-111 or in “The aqueous phase behavior of surfactants”, Robert G. Laughlin, Academic press, (1996), p. 521-546.

In addition, the compositions according to the invention form creams which are fluid to a greater or lesser extent, whose moduli |G*| may have, at a temperature of 25° C., values ranging from 10² to 10⁵ Pa and loss angles δ ranging from 10° to 45° for frequencies ranging from 10⁻² to 10 Hz.

|G*| and δ are the viscoelastic parameters used in order to measure the physical properties of viscoelastic fluids as explained in “An introduction to rheology” by H. A. BARNES, J. F. HUTTON, K. WALTERS, pages 46 to 54, (Ed. Elsevier—1989).

|G*| is the modulus of the complex modulus G* and δ is the loss angle. G′ and G″ are the components of G*:G*=G′+iG″. G′ and G″ are respectively the storage modulus and the loss modulus and is equal to (−1)^{½}. The components G′ and G″ of the complex modulus are obtained from the relation between the sinusoidal stress (oscillatory stress) and the sinusoidal strain (oscillatory strain).

The rheological measurements of |G*| and δ are generally carried out using a Haake RS150 rheometer, at a temperature of 25° C., with measuring bodies of cone-plate geometry, the diameter of the cone and the diameter of the plate being 60 mm, the angle of the cone being 2° and the air gap between the cone and the plate being 0.1 mm.

In order to make dynamic viscoelasticity measurements (oscillatory measurements), the linear viscoelastic region is first determined by subjecting the sample to sinusoidal stresses of growing amplitude and of constant frequency. The moduli are reported as a function of the amplitude of the stress or of the amplitude of the strain in order to determine the limits of the linear viscoelastic region. After having identified the linear viscoelastic region, dynamic measurements are carried out in the linear viscoelastic zone, for a constant strain value situated in the linear viscoelastic region and at variable frequency. The Haake RS150 rheometer is able to cover a range of frequencies varying from 0.01 to 10 Hz (or 0.063 to 62.8 rad/sec).

From values of amplitudes of the stress τ₀, of the strain γ₀, as well as from the phase lag δ, the following relations are established:

$$\vert {G}^{*} \vert = \frac{{τ}_{0}}{{γ}_{0}}$$

G′=|G*|cos δ

G″=|G*|sin δ

G*=G′+iG″

Surfactant System

The surfactant system used in the composition of the invention and allowing the appearance of a paracrystalline phase to be obtained during heating to at least 30° C. preferably comprises at least one water-soluble surfactant and at least one surfactant which is insoluble in water.

“Water-soluble” is understood as meaning a surfactant which, at a concentration of 20 g/l in softened water at a temperature of approximately (±10%) 25° C., gives a transparent isotropic solution.

Conversely, “surfactant which is insoluble in water” is understood as meaning a surfactant which, at a concentration of 20 g/l in softened water at a temperature of approximately 25° C., gives a cloudy solution indicating the nonsolubilization of the surfactant in the water.

Water-soluble Surfactants

It is possible to use any surfactant soluble in water. These are preferably foaming surfactants, that is to say surfactants apt to foam in the presence of water. These are principally anionic, nonionic or amphoteric derivatives having fatty chains which are sufficiently short for these products to be very soluble at ambient temperature in the aqueous solvent medium of the composition. It is possible to use a water-soluble surfactant or a mixture of such surfactants.

Useful water-soluble surfactants include, for example:

1. Anionic Surfactants

According to a particular embodiment of the invention, the surfactant system used preferably comprises at least one water-soluble anionic surfactant, and more particularly at least one carboxylic acid or one water-soluble carboxylic acid salt, which salt is obtained from the acid and a base. The carboxylic acids which can be used are fatty acids, containing a linear or branched, saturated or unsaturated alkyl chain having for example from 6 to 16 carbon atoms and preferably 10 to 14 carbon atoms. The salts of such fatty acids form soaps. The fact of whether a soap is water-soluble or not depends both on the length of the alkyl chain and that of the counterion forming the salt. As salts, it is possible to use, for example, alkali metal salts, alkaline earth metal salts, the salts of ammonia, the salts of aminoalcohols and the salts of amino acids, and especially the salts of sodium, of potassium, of magnesium, of triethanolamine, of N-methylglucamine, of lysine and of arginine. The bases which can be used to produce these salts can, for example, be inorganic bases, such as alkali metal hydroxides (sodium hydroxide and potassium hydroxide), alkaline earth metal hydroxides (magnesium hydroxide) or ammonium hydroxide, or organic bases, such as triethanolamine, N-methylglucamine, lysine and arginine. The carboxylic acid can be, in particular, lauric acid or myristic acid.

As water-soluble soap, it is possible to mention, for example, the potassium salts of C10 to C14 fatty acids and their mixtures, in particular the potassium salt of lauric acid, the potassium salt of myristic acid and their mixtures.

Soap is generally introduced into the composition in the form of a base, on the one hand, and of the fatty acid, on the other hand, the formation of the salt taking place in situ. Thus, when the water-soluble soap is composed of the potassium salt of lauric acid and/or of the potassium salt of myristic acid, the composition can then comprise lauric acid and/or myristic acid with a sufficient amount of potassium hydroxide to form the potassium salts of lauric acid and/or of myristic acid.

In addition to the carboxylic acids and their salts indicated above, other anionic surfactants which can be used in the composition of the invention as water-soluble surfactant include, for example, ethoxylated carboxylic acids and their salts; sarcosinates and acyl-sarcosinates and their salts such as sodium lauroyl sarcosinate; taurates and methyltaurates and their salts; isethionates and acylisethionates, reaction products of fatty acids containing 10 to 22 carbon atoms, with isethionic acid, and their salts such as sodium isethionate and sodium cocoyl-isethionate; sulphosuccinates and their salts; alkylsulphates and alkyl ether sulphates and their salts, especially sodium or triethanolamine lauryl sulphate, and sodium or potassium lauryl ether sulphate; monoalkyl and dialkyl esters of phosphoric acid and their salts, such as, for example, sodium mono- and dilauryl phosphate, potassium mono- and dilauryl phosphate, triethanolamine mono- and dilauryl phosphate, sodium mono- and dimyristyl phosphate, potassium mono- and dimyristyl phosphate, diethanolamine mono- and dimyristyl phosphate, triethanolamine mono- and dimyristyl phosphate; alkanesulphonates and their salts; bile salts such as cholates, deoxycholates, taurocholates and taurodeoxycholates; lipoamino acids and their salts such as mono- and disodium acyl-glutamates; geminal, bipolar surfactants, such as described in Surfactant Science series, vol. 74 Edition Krister Homberg; and their mixtures.

2. Amphoteric and Zwitterionic Surfactants

Amphoteric or zwitterionic surfactants useful as water-soluble surfactants include, for example, betaines such as dimethylbetaine, coco-betaine and coco-amidopropyl-betaine; sulphobetaines such as coco-amidopropyl- hydroxysultaine; alkylamphoacetates such as coco-amphodiacetate; and their mixtures.

3. Nonionic Surfactants

Nonionic surfactants useful as water-soluble surfactants include, for example

polyol ethers, containing fatty chains (8 to 30 carbon atoms), such as the fatty ethers of sorbitol or of oxyethylenated glyceryl;

polyglycerol ethers and esters;

polyoxyethylenated fatty alcohols which are ethers formed of ethylene oxide units and at least one fatty alcohol chain having from 10 to 22 carbon atoms, whose solubility depends on the ethylene oxide number and on the length of the fatty chain; for example, for a fatty chain containing 12 carbon atoms, the ethylene oxide number must be greater than 7, and by way of example of polyoxyethylenated fatty alcohols, it is possible to mention the ethers of lauryl alcohol containing more than 7 oxyethylenated groups;

alkyl polyglucosides whose alkyl group contains from 1 to 30 carbon atoms, such as, for example, decyl glucoside such as the product marketed under the name ORAMIX NS 10 by the company SEPPIC or that marketed under the name MYDOL 10 by the company KAO, lauroyl glucoside, ketostearyl glucoside, coco-glucoside as the product marketed under the name PLANTACARE 818 by the company COGNIS;

alkyl glucopyranosides and alkyl thiogluco-pyranosides;

alkyl maltosides;

alkyl N-methylglucamide;

the polyoxyethylenated esters of sorbitan or of glycerol which generally contain from 1 to 100 ethylene glycol units and preferably from 2 to 40 ethylene oxide (EO) units, such as, for example, PEG-7 glyceryl cocoate such as the product marketed under the name CETIOL HE by the company COGNIS;

the esters of aminoalcohols; and their mixtures.

In the composition of the invention, the content of water-soluble surfactant(s) is not limited as long as the necessary paracrystalline phase is produced as specified. Preferably the amount may range, for example, from 10 to 50% by weight, more preferably from 15 to 35% by weight, with respect to the total weight of the composition. According to a preferred embodiment of the invention, the composition of the invention comprises at least 10% by weight, preferably at least 15% by weight and better still at least 20% by weight, of water-soluble surfactant(s) with respect to the total weight of the composition.

Water-insoluble Surfactants

Surfactants which are insoluble in water especially contribute to the texture (consistency) of the final composition. In addition, in the temperature range between approximately 25 ° C. and 45 ° C., these surfactants associate in part with the water-soluble surfactants to contribute to the formation of the (preferably direct hexagonal) paracrystalline phase which it is believed is at the origin of the stability of the product up to at least 45° C.

Useful surfactants which are insoluble in water that may be used in the compositions according to the invention include the carboxylic acids and their salts, which are insoluble in water, which salts may be obtained from the acid and a base, and thus soaps which are insoluble in water, that is to say the insoluble salts of carboxylic acids containing a saturated or unsaturated, linear or branched alkyl chain having from 6 to 30 carbon atoms, preferably 12 to 24 carbon atoms. For the derivatives containing a single saturated fatty chain, the chain advantageously comprises from 12 to 30 carbon atoms, preferably from 14 to 22 carbon atoms and better still from 16 to 20 carbon atoms. For the derivatives containing a monounsaturated or polyunsaturated or branched fatty chain, the chain advantageously comprises from 16 to 30 carbon atoms and preferably from 18 to 24 carbon atoms.

Useful carboxylic acids include palmitic acid and stearic acid. Useful salts include alkali metal salts, alkaline earth metal salts, the salts of ammonia, salts of aminoalcohols and the salts of amino acids, and especially the salts of sodium, of potassium, of magnesium, of triethanolamine, of N-methylglucamine, of lysine and of arginine. The bases which can be used to produce these salts can, for example, be inorganic bases, such as alkali metal hydroxides (sodium hydroxide and potassium hydroxide), alkaline earth metal hydroxides (magnesium hydroxide) or ammonium hydroxide, or organic bases, such as triethanolamine, N-methylglucamine, lysine and arginine.

The insoluble soaps include the sodium salt of fatty acids of C12 to C22, the potassium salt of fatty acids of C16 to C22, and their mixtures, and especially the potassium salt of palmitic acid, the potassium salt of stearic acid and their mixtures.

In addition to the carboxylic acids and their salts indicated above, other surfactants which can be used in the composition of the invention as insoluble surfactant include for example nonionic or anionic insoluble surfactants, and more particularly:

glyceryl and fatty acid esters containing from 14 to 30 carbon atoms, such as glyceryl stearate like the product marketed under the name stearate de glycerol by the company Stearineries Dubois, the mixture of glyceryl stearate and of PEG-100 stearate, marketed under the name Arlacel 165 by the company Uniqema and under the name Simulsol 165 by the company Seppic, the product marketed under the name Tegin M by the company Goldschmidt, the mixture of glyceryl monostearate and potassium stearate marketed under the name Tegin Pellets by the company Goldschmidt; the glyceral laurate marketed under the name Tegin L90 by the company Goldschmidt;

the optionally oxyethylenated derivatives of sterols and of phytosterols;

the alkali metal salts of cholesterol sulphate, and in particular the sodium salt;

the alkali metal salts of cholesterol phosphate, and in particular the sodium salt;

polyoxyethylenated fatty alcohols containing an oxyethylenated chain having a small number of oxy-ethylenated groups, and in particular less than 10 oxy-ethylenated groups;

dialkyl phosphates such as the alkali metal salts of dicetyl phosphate, and in particular the sodium and potassium salts; and the alkali metal salts of dimyristyl phosphate, and in particular the sodium and potassium salts;

lecithins;

sphingomyelins;

ceramides;

and their mixtures.

The composition can comprise one or more water-soluble surfactants, and one or more insoluble surfactants, it being possible for these surfactants to be anionic, nonionic and/or amphoteric.

The composition of the invention preferably comprises a content of surfactant(s) which is/are insoluble in water ranging from 5 to 50%, and preferably from 5 to 30%, by weight with respect to the total weight of the composition. However, any amount may be used as long as the requisite paracrystalline phase(s) is/are produced as specified.

The surfactant system (e.g., water-soluble and insoluble surfactants) is present in the composition of the invention in a quantity that produces the specified paracrystalline phase(s) as noted above, which can range, for example, from 15 to 65% by weight, and preferably ranges from 20 to 65% by weight, better still from 30 to 50% by weight and even better still from 30 to 45% by weight, with respect to the total weight of the composition, these ranges including all values and subranges therebetween such as 32, 34, 36, 38, 40, 42 and 44% by weight. Preferably, the composition of the invention comprises one or more soaps (water-soluble and/or insoluble) in a total quantity of preferably at least 10% and better still of at least 20% by weight with respect to the total weight of the composition and preferably ranging from 30 to 40% by weight with respect to the total weight of the composition, the quantity of water-soluble soap(s) preferably being from at least 5% and better still from at least 10% by weight with respect to the total weight of the composition, again including all amounts, values and subranges.

### Fibers

The fibers utilizable in the composition of the invention can be hydrophilic or hydrophobic fibers, of synthetic or natural, inorganic or organic origin.

These fibers can be short or long, unitary, or organized, for example, in braided form. Their form or morphology can be of any type and includes especially circular or polygonal section (square, hexagonal or octagonal) according to the application specifically envisaged. In particular, their ends may be blunted and/or polished in order to avoid injury.

In particular, the fibers can have a length (L) ranging from 1 μm (0.001 mm) to 10 mm, preferably from 0.1 μm to 5 mm and better still from 0.1 mm to 1.5 mm. Their section can be included in a circle of diameter (D) ranging from 1 nm (0.001 μm) to 100 μm, preferably ranging from 1 nm (0.001 μm) to 50 μm and better still from 5 μm to 40 μm.

Preferably, the fibers used according to the present invention have a form factor, that is to say an L/D (length/diameter) ratio ranging from 3.5 to 2500, better still from 5 to 500 and even better still from 5 to 150.

The titer of the fibers is often given in denier or decitex. The denier is the weight in grams for 9 km of thread. Preferably, the fibers used according to the invention have a titer ranging from 0.15 to 30 denier, and better still from 0.18 to 18 denier.

The form factor, the titer and the morphology of the fibers are the three important factors for defining a fiber.

The fibers can be those used in the manufacture of textiles and especially fibers of silk, of cotton, of wool, of flax, of cellulose extracts, especially of wood, of vegetables or of algae, of polyamide (Nylon®), of modified cellulose (rayon, viscose, acetate, especially rayon acetate), of poly-p-phenylene terephthalamide, especially of Kevlar®, of acrylic, especially of methyl polymethacrylate or of poly 2-hydroxyethyl methacrylate, of polyolefin and especially of polyethylene or of polypropylene, of glass, of silica, of aramid, of carbon, especially in the form of graphite, of Teflon®, of insoluble collagen, of polyesters, of poly vinyl or vinylidene chloride, of polyvinyl alcohol, of polyacrylonitrile, of chitosan, of polyurethane, of polyethylene phthalate, of fibers formed of a mixture of polymers such as those mentioned above, such as fibers of polyamide/polyester, and their mixtures.

Examples of polyurethane fibers which may be mentioned include poly(urethane-urea) polymer fibers, belonging to the elastane class, and especially those sold under the name Lycra® by the company DuPont.

It is likewise possible to use the absorbable synthetic fibers used in surgery, such as the fibers prepared from glycolic acid and caprolactone (MONOCRYL from the company JOHNSON & JOHNSON); absorbable synthetic fibers of the lactic acid and glycolic acid copolymer type (VICRYL from the company JOHNSON & JOHNSON); the fibers of terephthalic polyester (ETHIBOND from the company JOHNSON & JOHNSON) and filaments of stainless steel (ACIER from the company JOHNSON & JOHNSON).

It is likewise possible to use mixtures of the fibers mentioned above.

Moreover, the fibers may or may not be surface-treated and may be coated or uncoated. They may especially be coated and/or functionalized fibers, the term “functionalized” meaning that the fibers are surface-treated so as to modify their properties.

As coated fibers which can be used in the invention, it is possible to mention fibers of polyamide coated with copper sulphide for an antistatic effect (for example R-STAT from the company RHODIA) or another polymer allowing a particular organization of the fibers (specific surface treatment) or surface treatment inducing colour/hologram effects (LUREX from the company SILDOREX, for example).

The fibers can also be functionalized, that is to say be modified so as to have a specific function. This functionalization of the fibers can be carried out both on the fibers and in the fibers and by any method which makes it possible to attach a compound to the fibers or to trap it within the cavities formed by the geometry of the fibers. Methods include, for example, coating the fibers with an active principle; fixing, to the fibers, particles enclosing an active principle, such as nanocapsules or nanospheres; adsorption in the fibers; or fixing by chemical reaction. It is thus possible to use fibers having specific functional purposes, for example fibers which are stabilized against UV radiation by modification with chemical or physical sunscreens; fibers which have been rendered bactericidal or antiseptic by modification with preservatives or antibacterials; fibers which have been coloured by modification with colouring molecules; fibers which have been rendered keratolytic or desquamating by modification with keratolytic or desquamating agents; fibers which have been rendered hydrating by modification with hydrating agents or water-retaining polymers; fibers which have been rendered fragrant by modification with a fragrance; fibers which have been rendered analgesic or soothing by modification with an antiinflammatory or a soothing agent; or fibers which have been rendered resistant to perspiration by modification with an antiperspirant.

According to their properties, the fibers used according to the present invention can be introduced into an aqueous medium, an oily medium or into a powder.

The fibers utilizable according to the invention are preferably chosen from polyamide fibers, poly-p-phenylene terephthalamide fibers, cotton fibers and their mixtures. Their length can preferably range from 0.1 to 10 mm, preferably from 0.1 to 1 mm, their mean diameter can range from 5 to 50 μm and the form factor preferably ranges from 5 to 150.

In particular, it is possible to use the polyamide fibers marketed by ETABLISSEMENTS P. BONTE under the name POLYAMIDE 0.9 dtex 0.3 mm, having a mean diameter of 15 to 20 μm, a titer of approximately 0.9 dtex (0.81 denier) and a length ranging from 0.3 mm to 1.5 mm. It is likewise possible to use poly-p-phenylene terephthalamide fibers of 12 μm mean diameter and of approximately 1.5 mm length such as those sold under the name of KEVLAR FLOC by DUPONT FIBERS. These polyamide fibers are preferably introduced into an oily medium or, by a dry method, into a powder.

Cotton fibers with a mean diameter of 20 μm, a length of 0.3 mm and a shape factor of 15 may also be used, such as those sold by the company Filature de Lomme, by the company Textiles des Dunes, by the Institut Textile de France or by the company Velifil.

The fibers can be present in the composition according to the invention in any quantity, and preferably range, for example, from 0.001 to 20% by weight, preferably from 0.1 to 15% by weight, better still from 0.3 to 10% by weight and even better still from 0.5 to 10% by weight including all values and subranges therebetween such as 1, 2, 3, 4, 5, 6, 7, 8 and 9% with respect to the total weight of the composition.

Possible Other Ingredients (Non-limiting)

The aqueous medium of the foaming creams of the invention can contain, in addition to water, one or more solvents chosen from lower alcohols containing 1 to 6 carbon atoms, such as ethanol; polyols such as glycerol; glycols such as butylene glycol, isopropylene glycol, propylene glycol, polyethylene glycols such as PEG-8; sorbitol; sugars such as glucose, fructose, maltose, lactose, sucrose; and their mixtures. The quantity of solvent(s) in the composition of the invention can range from 0.5 to 30% by weight and preferably from 5 to 20% by weight with respect to the total weight of the composition.

In order to obtain compositions which are fluid to a greater or lesser degree, it is possible to incorporate into the compositions of the invention one or more thickening agents, especially polymers, in preferential concentrations ranging from 0.05 to 2% by weight with respect to the total weight of the composition. It is possible to mention as examples of thickeners, polysaccharide biopolymers such as xanthan gum, guar gum, alginates, modified celluloses; synthetic polymers such as polyacrylics like CARBOPOL 980 marketed by the company GOODRICH, acrylate/acrylonitrile copolymers such as HYPAN SS201 marketed by the company KINGSTON; inorganic thickeners such as smectites and modified or unmodified hectorites such as the products BENTONE marketed by the company RHEOX, the products LAPONITE marketed by the company SOUTHERN CLAY PRODUCTS and the product VEEGUM HS marketed by the company R. T. VANDERBILT; their mixtures.

The compositions of the invention can also contain adjuvants customarily used in the field of foaming cleansers such as cationic polymers of the poly-quaternium type, which contribute softness and unctuousness to the foaming cream. These cationic polymers can preferably be chosen from the following polymers:

Polyquaternium 5 such as the product MERQUAT 5 marketed by the company CALGON;

Polyquaternium 6 such as the product SALCARE SC 30 marketed by the company CIBA, and the product MERQUAT 100 marketed by the company CALGON;

Polquaternium 7 such as the products MRTQUAT S, MERQUAT 2200 and MERQUAT 550 marketed by the company CALGON, and the product SALCARE SC 10 marketed by the company CIBA;

Polyquaternium 10 such as the product POLYMER JR400 marketed by the company AMERCHOL;

Polyquaternium 11 such as the products GAFQUAT 755, GAFQUAT 755N and GAFQUAT 734 marketed by the company ISP;

Polyquaternium 15 such as the product ROHAGIT KF 720 F marketed by the company ROHM;

Polyquaternium 16 such as the products LUVIQUAT FC905, LUVIQUAT FC370, LUVIQUAT HM552 and LUVIQUAT FC550 marketed by the company BASF;

Polyquaternium 22 such as the product MERQUAT 280 marketed by the company CALGON;

Polyquaternium 28 such as the product STYLEZE CC10 marketed by the company ISP;

Polyquaternium 39 such as the product MERQUAT PLUS 3330 marketed by the company CALGON;

Polyquaternium 44 such as the product LUVIQUAT CARE marketed by the company BASF;

Polyquaternium 46 such as the product LUVIQUAT HOLD marketed by the company BASF;

Polyquaternium 47 such as the product MERQUAT 2001 marketed by the company CALGON.

It is also possible to use as cationic polymer, cationic guars such as the product JAGUAR marketed by the company RHODIA.

In addition, the compositions of the invention can contain adjuvants customarily used in the cosmetic field, chosen from lipophilic or hydrophilic active agents, perfumes, preservatives, antioxidants, sequestrants (EDTA), pigments, nacres, inorganic or organic charges such as talc, kaolin, silica or polyethylene powders, soluble colorants, sun filters. The quantities of these different adjuvants are those conventionally used in the field considered, and, for example, from 0.01 to 20% of the total weight of the composition. These adjuvants as well as their concentrations should be such that they do not modify the property sought for the composition of the invention.

Useful active agents include, very particularly, antibacterial active agents especially allowing greasy skins to be treated. This active agent can especially be chosen from: β-lactam derivatives, quinolone derivatives, ciprofloxacin, norfloxacin, tetracycline and its salts, erythromycin and its salts, amikacin and its salts, 2,4,4′-tri-chloro-2′-hydroxy diphenyl ether (or triclosan), 3,4,4′-trichlorobanilide, phenoxyethanol, phenoxypropanol, phenoxyisopropanol, doxycycline and its salts, capreomycin and its salts, chlorhexidine and its salts, chlorotetracycline and its salts, oxytetracycline and its salts, clindamycin and its salts, ethambutol and its salts, hexamidine isethionate, metronidazole and its salts, pentamidine and its salts, gentamycin and its salts, kanamycin and its salts, lineomycin and its salts, methacycline and its salts, methenamine and its salts, minocycline and its salts, neomycin and its salts, netilmycin and its salts, paromomycin and its salts, streptomycin and its salts, tobramycin and its salts, miconazole and its salts, the salts of amanfadine, para-chloro-meta-xylenol, nystatin, tolnaftate, salicylic acid and its salts, N-octanoyl-5 salicylic acid and its salts, benzoyl peroxide, 3-hydroxybenzoic acid, 4-hydroxy-benzoic acid, acetylsalicylic acid, 2-hydroxybutanoic acid, 2-hydroxypentanoic acid, 2-hydroxyhexanoic acid, phytic acid, N-acetyl-L-cysteine acid, lipoic acid, azelaic acid, arachidonic acid, ibuprofen, naproxen, hydrocortisone, acetominophene, resorcinol, octopirox, lidocaine hydrochloride, clotrimazole, octoxyglycerine, octanoylglycine, caprylylglycol, 10-hydroxy-2-decanoic acid, salts of zinc such as zinc gluconate, niacinamide or vitamin B3 (or vitamin PP) and their mixtures.

The composition according to the invention can especially form foaming creams for topical application, used in particular in the cosmetic or dermatological fields, as products for cleansing or removing make-up from the skin (body or face including eyes), the scalp and/or the hair. It can more particularly form a composition for cleansing the skin, and especially a composition for the cleansing of greasy skins and/or of hair with a greasy tendency, especially when it contains one or more antibacterial active agents indicated above.

Another subject of the invention is the cosmetic use of the composition such as defined above as a product for cleansing and/or removing make-up from the skin, the scalp and/or the hair.

Another subject of the invention is the cosmetic use of the composition such as defined above as a product for cleansing and/or removing make-up from greasy skins and/or hair with a greasy tendency.

The invention also relates to the use of a composition such as defined above for the preparation of a product intended for the treatment of greasy skins and/or greasy hair. The composition then preferably contains one or more antibacterial agents.

These creams intended in particular for the cleansing of the skin develop foam when they are mixed with water. They can be used for example in the following two ways:

spreading the cream in the hands, in applying it to the face or to the body and then massaging it in the presence of water to develop the foam directly on the face or the body.

developing the foam in the palms of the hands before being applied to the face or the body.

In both cases, the foam may then be rinsed.

Another subject of the invention is a cosmetic process for cleansing the skin, the scalp and/or the hair, characterized by the fact that the composition of the invention is applied to the skin, to the scalp and/or to the hair, in the presence of water, and that the foam formed and the residues of soiling are eliminated by rinsing with water.

The examples which follow serve to illustrate the invention without, however, having a limiting character. The quantities indicated are in % by weight except for mention to the contrary, and the names of the compounds in chemical names or CTFA names (International Cosmetic Ingredient Dictionary and Handbook) according to the case.

| Composition | Example 1 | Example 2 |
|---|---|---|
| Phase A | | |
| Lauric acid | 3% | 3% |
| Myristic acid | 20% | 20% |
| Stearic acid | 3% | 3% |
| Palmitic acid | 3% | 3% |
| Glyceryl stearate SE | 5% | 5% |
| Phase C1 | | |
| Coco-glucoside (at 52% of M.A.) | 2% M.P. | 2% M.P. |
| | (or 1.04% of M.A.) | (or 1.04% of M. A.) |
| Phase C2 | | |
| Potassium hydroxide (pure) | 7% | 7% |
| Phase D | | |
| Polyamide fibres(Polyamide 0.9 | 5% | 5% |
| dtex, 0.3 mm - Paul Bonte) | | |
| Phase B | | |
| Glycerol | 7% | 21% |
| PEG-8 | 7% | 0 |
| Preservatives | 0.7% | 0.7% |
| EDTA (sequestrant) | 0.2% | 0.2% |
| Water | Qsp | Qsp |
| | 100% | 100% |
| Appearance | Pearly white product | Pearly white product |
| pH at 24 h | 9.17 | 9.42 |
| Stability at all temperatures | Perfect after 2 months | Perfect after 2 months |
| 4° C./25° C./45° C. | months | months |

The compositions obtained have the appearance of a homogeneous white cream. The stability of these creams is perfect at 4° C., at ambient temperature and at 45° C. for at least two months, which signifies that, under the microscope, the edges of the composition are distinct, that they have a homogeneous aspect and that there is no development of odour or of colour.

Operating method: The aqueous phase formed of water-soluble ingredients (water, preservatives, EDTA, glycerol, PEG-8) is brought to 80° C. The fatty phase formed of fatty acids and of the glyceryl stearate is heated and added with stirring to the aqueous phase. The coco-glucoside is then added and then the potassium hydroxide is solubilized in one part of the water. The stirring is maintained for 10 minutes at 80° C., then the whole is cooled with stirring.

In all the examples, the water-soluble surfactants formed of potassium salts of lauric and myristic acids, and of coco-glucoside represent more than 25% (28.6%) by weight of the composition, while the surfactants which are insoluble in water, formed of the potassium salts of palmitic and stearic acids, and of glyceryl stearate represent less than 15% (13.3%) by weight of the composition. The compositions of examples 1 and 2 in total contain 41.9% of surfactants including 36% of soaps (KOH+lauric, myristic, palmitic and stearic acids).

Sensory performance: the foam qualities of the compositions of example 2 have been evaluated according to the protocol described below:

Before every use of the product, the hands are washed with Marseilles soap and then suitably rinsed and dried. The protocol followed is then as follows:

1—wet the hands by passing them under running water, shake them three times to dry them,

2—place 1 g of product in the hollow of one of the hands,

3—work the product between the two palms for 10 seconds,

4—add 2 ml of water and work the product again for 10 seconds,

5—rinse the hands under water,

6—dry them.

The criteria are evaluated at each step of the protocol followed, and they are recorded on a scale of 0 to 10.

step 3: evaluation of the covering power: the mark attributed is all the higher if the skin is not seen through the spread product.

step 4: evaluation of the foam quality

The volume of foam: the mark attributed is all the higher if the volume is large.

The size of the bubbles forming the foam: the mark attributed is all the higher if the bubbles are large.

The density: consistency, quality of the foam: the mark attributed is all the higher if the density is high.

The softness of the foam: the mark attributed is all the higher if the foam is soft.

step 5: evaluation during rinsing

Rinsing: the mark attributed is all the lower if the presence of a slippery film which is difficult to remove is high.

These foam qualities have been evaluated for the composition of example 2 and for an identical composition not containing fibres (comparative example 2).

The sensory results for each of the criteria are presented in the following table:

| | Ex. 2 according to | Comparative ex. |
|---|---|---|
| | the invention | 2 |
| Volume of the foam | 5.7 | 4.6 |
| Size of the bubbles | 3.8 | 2.9 |
| Density | 7.0 | 7.7 |
| Softness of the foam | 8.7 | 8.3 |
| Rinsing | 8.6 | 8.7 |

These results show that the compositions obtained have a very small bubble size, a very high softness and very good rinsing qualities, and that the incorporation of fibres does not modify the foam qualities of the compositions, which is particularly surprising because the addition of additives generally affects the qualities of the foam of a composition.

Dullness test: a dullness test was carried out on the composition of example 1 comparatively to an identical composition not containing fibres (comparative example 1).

To carry out this test, the composition to be tested was spread on a rubber support, at a rate of 2 g/cm². After drying, the reflection was measured with the aid of a gonioreflectometer (MICROMODULE gonioreflecto-meter) at ambient temperature (approximately 20 to 25° C.), the result being the ratio R between the specular reflection and the diffuse reflection. The value of R is all the lower if the dulling effect is significant.

Composition

| | Comparative | Ex. 1 of the |
|---|---|---|
| | Ex. 1 | invention |
| | Without fibres | With fibres |
| R | 6.75 ± 0.45 | 2.40 ± 0.35 |

This table shows that the composition of the example according to the invention has a dulling effect which is much more significant than the composition of the comparative example, which contributes an extra quality to the composition of the invention.

French patent application 0105927 filed May 3, 2001, is incorporated herein by reference, as are all documents, reports, standards, articles and texts referred to above.

1. A foaming composition comprising, in an aqueous medium, fibres and a surfactant system, wherein at least one paracrystalline phase selected from the group consisting of a direct hexagonal phase, cubic phase, and a mixture thereof appears when the temperature increases beyond 30° C., said paracrystalline phase remaining present up to at least 45° C.

2. The composition according to claim 1, wherein the composition exhibits at least one direct hexagonal phase.

3. The composition according to claim 1, wherein the surfactant system comprises a water-soluble surfactant and a surfactant which is insoluble in water.

4. The composition according to claim 3, wherein the water-soluble surfactant is selected from the group consisting of anionic surfactants, nonionic surfactants, amphoteric surfactants and mixtures thereof.

5. The composition according to claim 3, wherein the surfactant system comprises a water-soluble anionic surfactant.

6. The composition according to claim 5, wherein the water-soluble anionic surfactant is selected from the group consisting of carboxylic acids and their salts, ethoxylated carboxylic acids and their salts, sarcosinates and acylsarcosinates and their salts, taurates and methyltaurates and their salts, isethionates and acylisethionates and their salts, sulphosuccinates and their salts, alkylsulphates and alkyl ether sulphates and their salts, the monoalkyl and dialkyl esters of phosphoric acid and their salts, alkanesulphonates and their salts, bile salts, lipoamino acids and their salts, geminal surfactants, and mixtures thereof.

7. The composition according to claim 6, wherein the water-soluble surfactant is a salt of a fatty acid having a linear or branched, saturated or unsaturated alkyl chain having from 10 to 14 carbon atoms.

8. The composition according to claim 7, wherein the water-soluble surfactant is a potassium salt of a C10 to C14 fatty acid.

9. The composition according to claim 4, wherein the water-soluble surfactant is selected from the group consisting of the potassium salt of lauric acid, the potassium salt of myristic acid, and mixtures thereof.

10. The composition according to claim 3, wherein the water-soluble surfactant is an amphoteric or zwitterionic surfactant selected from the group consisting of betaines, sulphobetaines, alkylamphoacetates, and mixtures thereof.

11. The composition according to claim 4, wherein the water-soluble surfactant is a nonionic surfactant selected from the group consisting of polyol ethers, polyglycerol ethers and esters, polyoxyethylenated fatty alcohols, alkyl polyglucosides, alkyl glucopyranosides and alkylthioglucopyranosides, alkyl maltosides, alkyl N methyl glucamide, the polyoxyethylenated esters of sorbitan or of glycerol, the esters of aminoalcohols, and mixtures thereof.

12. The composition according to claim 4, wherein the surfactant which is insoluble in water is selected from the group consisting of carboxylic acids and their salts; glyceryl and fatty acid esters; the optionally oxyethylenated derivatives of sterols and of phytosterols; the alkali metal salts of cholesterol sulphate; the alkali metal salts of cholesterol phosphate; polyoxyethylenated fatty alcohols; dialkyl phosphates; lecithins; sphingomyelins; the ceramides, and mixtures thereof.

13. The composition according to claim 4, wherein the surfactant which is insoluble in water is selected from the group consisting of salts of carboxylic acids containing a saturated or unsaturated, linear or branched alkyl chain having from 12 to 24 carbon atoms.

14. The composition according to claim 4, wherein the surfactant which is insoluble in water is selected from the group consisting of the sodium salt of fatty acids of C12 to C22, the potassium salt of fatty acids of C16 to C22, and mixtures thereof.

15. The composition according to claim 4, wherein the surfactant which is insoluble in water is selected from the group consisting of potassium salt of palmitic acid, the potassium salt of stearic acid, and mixtures thereof.

16. The composition according to claim 1, wherein the surfactant system is present in a quantity ranging from 15 to 65% by weight with respect to the total weight of the composition.

17. The composition according to claim 3, comprising from 10 to 50% by weight of water-soluble surfactant with respect to the total weight of the composition.

18. The composition according to claim 3, comprising at least 10% by weight of water-soluble surfactant with respect to the total weight of the composition.

19. The composition according to claim 3, comprising from 5 to 50% by weight of surfactant which is insoluble in water with respect to the total weight of the composition.

20. The composition according to claim 1, comprising one or more soaps in a total quantity of at least 20% by weight with respect to the total weight of the composition.

21. The composition according to claim 20, comprising at least 5% by weight of water-soluble soap with respect to the total weight of the composition.

22. The composition according to claim 1, wherein the fibres have a length (L) ranging from 1 μm to 10 mm.

23. The composition according to claim 1, wherein the fibres have a section included in a circle of diameter (D) ranging from 1 nm to 100 μm.

24. The composition according to claim 1, wherein the fibres have a form factor (L/D) ranging from 5 to 150.

25. The composition according to claim 1, wherein the fibres have a titer ranging from 0.15 to 30 denier.

26. The composition according to claim 1, wherein the fibres are selected from the group consisting of the fibres of silk, of cotton, of wool, of flax, of cellulose extracts, especially of wood, of vegetables or of algae, of polyamide (Nylon®), of modified cellulose, of poly-p-phenylene terephthalamide, of acrylic, of polyolefin, of glass, of silica, of aramid, of carbon, of Teflon®, of insoluble collagen, of polyesters, of polyvinyl or polyvinylene chloride, of polyvinyl alcohol, of polyacrylonitrile, of chitosan, of polyurethane, of polyethylene phthalate, of fibres formed of a mixture of polymers, absorbable synthetic fibres, and mixtures thereof.

27. The composition according to claim 1, wherein the fibres are coated and/or functionalized.

28. The composition according to claim 1, wherein the fibres are selected from the group consisting of polyamide fibres, poly-p-phenylene terephthalamide fibres, cotton fibres, and mixtures thereof.

29. The composition according to claim 1, wherein the fibres are present in a quantity ranging from 0.001 to 20% by weight with respect to the total weight of the composition.

30. The composition according to claim 1, further comprising a solvent selected from the group consisting of lower alcohols; polyols; sugars, and mixtures thereof.

31. The composition according to claim 1, further comprising an antibacterial agent.

32. The composition according to claim 1, wherein said composition is in the form of a composition for cleansing the skin.

33. The composition of claim 1, wherein said composition is in the form of a cream.

34. A method comprising cleansing and/or removing make-up from the skin, the scalp and/or the hair with the composition of claim 1.

35. The method of claim 34 comprising cleansing and/or removing make-up from greasy skin and/or hair with a greasy tendency.

36. A method for cleansing the skin, the scalp and/or the hair, comprising applying the composition of claim 1 to the skin, to the scalp and/or to the hair, in the presence of water, forming a foam, and removing the residues of soiling by rinsing with water.
